(19) United States
(12) Patent Application Publication
(10) Pub. No.: US 2007/0121010 A1
(43) Pub. Date: May 31, 2007

(54) Method of setting video device in accordance with video input and video device that uses the method

(75) Inventor: Takanobu Sasaki, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/544,743

(22) Filed: Oct. 10, 2006

(30) Foreign Application Priority Data
Nov. 30, 2005 (JP) 2005-346087

(51) Int. Cl. H04N 5/46

(52) U.S. Cl. 348/558

(57) ABSTRACT

According to one embodiment, format data are stored by a last memory function for each of at least external input, and when an input is re-selected next time or the power is reset, the priority is given to the previously stored data through the last memory function, rather than the detection results of the current input, to carry out the image output control. The image output control is processed in parallel with the detection of the format of the current input.

### CROSS-REFERENCE TO RELATED APPLICATIONS

This application is based upon and claims the benefit of priority from Japanese Patent Application No. 2005-346087, filed Nov. 30, 2005, the entire contents of which are incorporated herein by reference.

### BACKGROUND

1. Field

One embodiment of the invention relates to an improvement of setting process in a video device (such as TV) that is equipped with an external video input. More specifically, it relates to the shortening of time required for the setting process in the apparatus carried out in accordance with the format (the scanning frequency and the like) of a video input to be displayed when the power is turned on or the video input is switched on.

2. Description of the Related Art

Recently, video signals of various formats are used. More specifically, there are NTSC standard vide signal (interlace of 480 scanning lines=480i: D1 format), progressive of 480 scanning lines (480p: D2 format), interlace of 1080 scanning lines (1080i: D3 format), progressive of 720 scanning lines (720p: D4 format), progressive of 1080 scanning lines (1080p D5 format), and so on. (There are more types of formats if analog RGB outputs of PAL and computers are included besides NTSC.)

Recent high-definition TV sets are compatible with analog video signal inputs of at least up to the D3 format. (There are a number of types of high-definition-incompatible TV sets that accept analog video signals of the D2 format so as to perform progressive reproduction of a DVD video.)

The video signals of the above-described various formats may have different attributes such as horizontal scanning frequency, frame rate and aspect ratio from one signal to another. Video devices (such as TV monitors, which are equipped with an image display unit, video processors and set top boxes, which are not equipped with an image display unit) are designed to accept video signals of various formats, and automatically set the internal status to be able to normally display video signals which are currently selected. More specifically, when an externally input video image of a format which is not known in advance, is to be viewed, the frequencies of the input video signals are detected to identify the format data. Thus, the internal register of the device is set for each format, and the image is output in a suitable state for the respective input video signal (, for example, at a scanning frequency that matches the input video signal). In many cases, a certain processing time is required to automatically set the internal status, and a viewer must wait for some time after a to-be-displayed video signal is selected until he or she can actually see an image output of the video signal.

In the case where a plurality of kinds of video signals are displayed while they are switched over from one to another, there is such a technical idea that the internal status corresponding to a video signal selected before, is stored (last memory function) to make the processing time shorter to output an image of the same video signal later. There is a conventional video device which utilizes the last memory function in the image outputting process. (See Jpn. Pat. Appln. KOKAI Publication No. 08-186770.)

Jpn. Pat. Appln. KOKAI Publication No. 08-186770 discloses a TV monitor equipped with both vide input and RGB input functions, and a further unction of switching the two types of video signals (of different formats) by an external control signal. The video signal switching unit of this TV monitor is structured such as to be able to select the priority between the external input signal when the power is turned on and the last memory function of the micro-computer.

On of the objects of the invention is to shorten the time required for the setting process in the device in accordance with the format (scanning frequency, etc.) of a video input to be displayed as an image when the power is turned on or the video input is switched on (, thereby becoming able to output the image more quickly as a result).

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram illustrating a general view a video device (in this case, a digital TV set equipped with a plurality of external video inputs) according to a first embodiment;

FIG. 2 is an explanatory diagram showing an example of the internal structure of the video device shown in FIG. 1;

FIG. 3 is a flowchart briefly illustrating an image device setting process according to the first embodiment;

FIG. 4 is a flowchart illustrating the process carried out when the power is turned on for the first time in the video device shown in FIG. 1; and

FIG. 5 is a flowchart illustrating the process carried out when the power is turned on for the next time or the video input is switched on in the video device shown in FIG. 1.

### DETAILED DESCRIPTION

Various embodiments according to the invention will be described hereinafter with reference to the accompanying drawings. In general, according to one embodiment of the invention, a video device comprises at least one video input unit, a selector that selects, as a video input, a video signal supplied to one of the at least one video input unit, a memory that stores format data of the video input, means for detecting a format of a video input selected by the selector and storing the latest format data in the memory, means for storing a result of detection of format data of a current video input as the latest format data in the memory, when the video input of the format data previously stored in the memory is not re-selected as a current input, or when the video input of the format data previously stored in the memory is not a current input and further a power is reset and means for carrying out image display control based on the format data previously stored in the memory with priority rather than the result of detection of the format data of the current video input, when the video input of the format data previously stored in the memory is re-selected as a current input, or when the video input of the format data previously stored in the memory is a current input and further a power is reset.

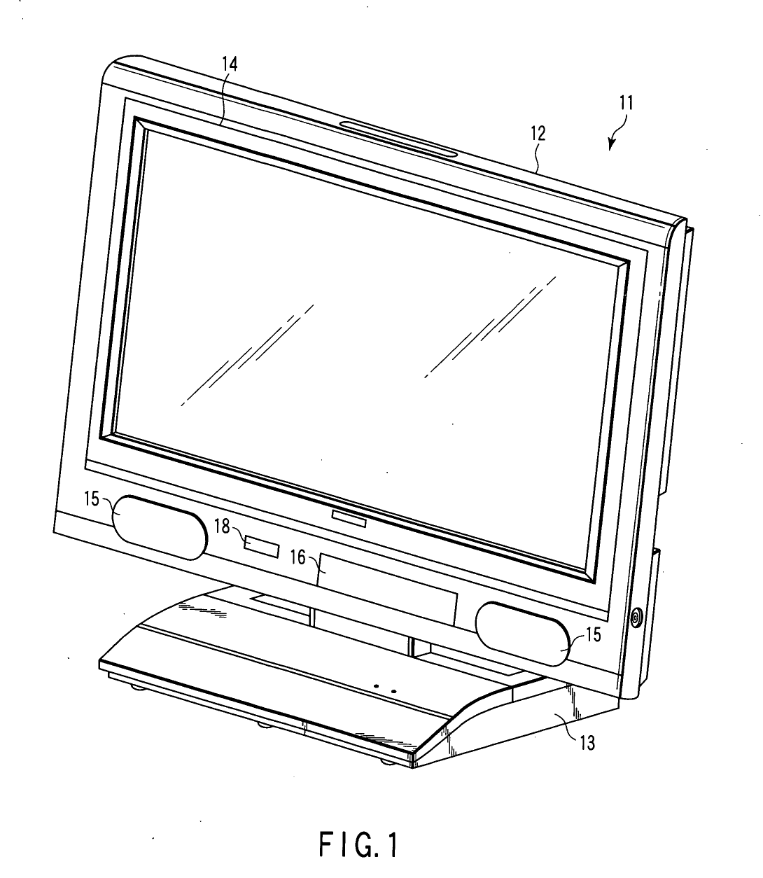

An embodiment of the invention will now be described with reference to accompanying drawings. FIG. 1 is a diagram illustrating a general view a video device (such as a flat-panel digital TV set) according to an embodiment of the invention. As shown in FIG. 1, a television broadcasting receiving device 11 includes a flat-type cabinet 12 having substantially a rectangular shape, which serves as a main body of the device, and a stand 13 that supports the cabinet 12 to stand up. The cabinet 12 includes, in its front side, a display region from which a video display unit 14 made of, for example, a flat-screen liquid crystal display panel, is exposed, a pair of speakers 15, a control unit 16 and a light receiving unit 18 which receives operation information transmitted from a remote controller, which will be later explained.

The stand 13 is formed to have a substantially thin box-shape structure, in which one of the flat surfaces thereof, which is a bottom surface plate, is designed to be placed on a certain table (not shown) that is horizontally set. The stand 13 includes a support member that projects upward from substantially a central portion of an upper surface plate, which is located on an opposite side to the surface placed on the table. As the support member is jointed to a back side of the cabinet 12, the stand 13 supports the cabinet 12 to stand up. The stand 13 has such a structure that can house an HDD unit (and/ore DVD video recorder unit) 20 inside the structure. The HDD unit will be described later. A plurality of operating elements are formed on the supper surface plate of the stand 13 at a section projecting to the front side further from the cabinet 12, and the operating elements are operated by pushing, in order to control recording, reproduction, stopping states of the HDD unit (and/ore DVD video recorder unit) 20.

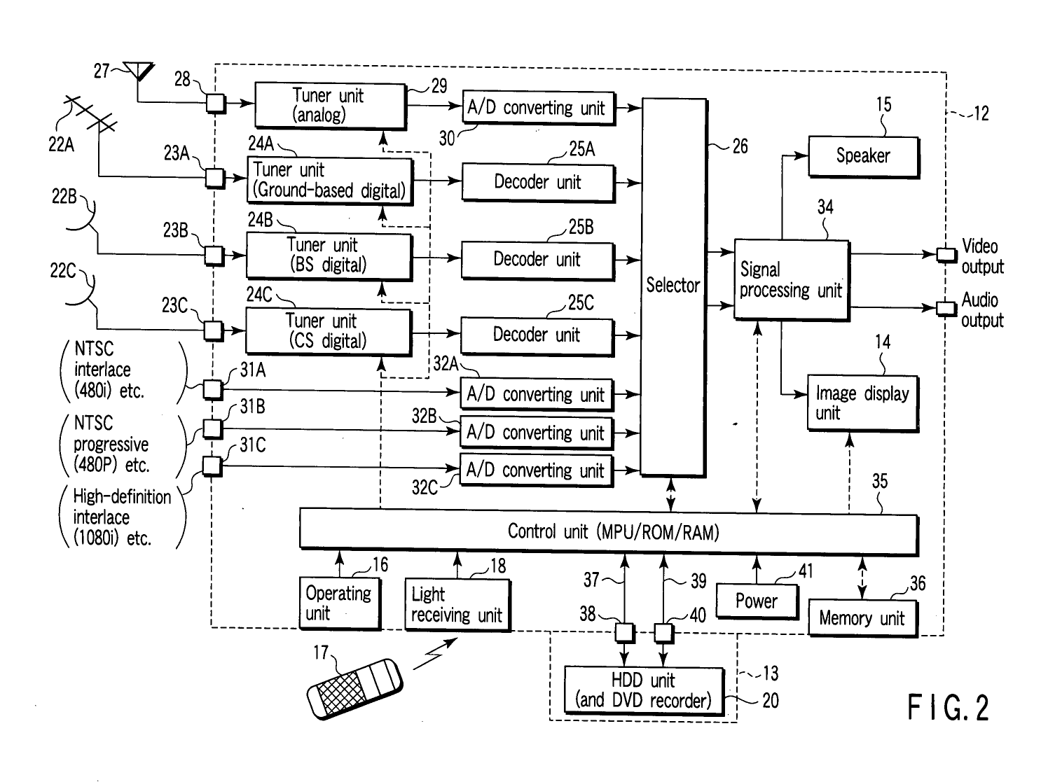

FIG. 2 is an explanatory diagram showing the internal structure of the video device (digital TV) shown in FIG. 1. FIG. 2 schematically shows a signal processing system of the television broadcasting receiving device 11. Various types of circuit blocks, which form the signal processing system, are placed mainly in a section close to the back side of the inside of the cabinet 12, that is, on a rear side of a display region 14a of the video display unit 14.

An analog television broadcast signal received via an antenna 27 for receiving analog television broadcasting is supplied via an input terminal 28 to a tuner unit 29. The tuner unit 29 selects a signal of a desired channel from the input analog television broadcast signal and demodulates the signal. The signal output from the tuner unit 29 is converted by an A/D (analog/digital) converting unit 30 into a digital signal, which is output to a selector 26. In the case where the thus A/D converted signal is to be recorded by the HDD unit (and/or DVD video recorder unit) 20, the signal is subjected to a compression process in a predetermined format (for example, MPE G2) in an encoder (not shown) attached to the selector 26, and then the compressed signal is recorded.

A digital television broadcast signal received an antenna 22A for receiving ground-based digital television broadcasting is supplied via an input terminal 23A to a tuner unit 24A. The tuner unit 24A selects a signal of a desired channel from the input digital television broadcast signal and demodulates the signal. The signal output from the tuner unit 24A is supplied to a decoder unit 25A, where the signal is subjected to, for example, an MPEG2 decoding process, and then the decoded signal is supplied to the selector 26.

A digital television broadcast signal received an antenna 22B for receiving satellite broadcasting is supplied via an input terminal 23B to a tuner unit 24B. The tuner unit 24B selects a stream signal of a desired channel from the input digital television broadcast signal and demodulates the signal. The signal output from the tuner unit 24B is supplied to a decoder unit 25B, where the signal is subjected to a decoding process, and then the decoded signal is supplied to the selector 26.

A digital television broadcast signal received an antenna 22C for receiving satellite broadcasting is supplied via an input terminal 23C to a tuner unit 24C. The tuner unit 24C selects a stream signal of a desired channel from the input digital television broadcast signal and demodulates the signal. The signal output from the tuner unit 24C is supplied to a decoder unit 25C, where the signal is subjected to a decoding process, and then the decoded signal is supplied to the selector 26.

It should be noted that the signal output signals (bit streams) of the digital broadcast receiving tuner units 24A, 24B and 24C may be supplied directly to the selector 26. (The signal supplying paths are now shown in the figure.) It is alternatively possible that the video-audio data packets, etc. are separated from these output signals and then directly recorded in the form of stream data on the HDD unit (and/or DVD video recorder unit) 20 via a control unit 35.

The selector 26 has such a structure that can receive a digitalized video signal obtained by converting an analog video input from an analog external input terminal 31A (such as a composite video terminal, an S terminal for Y/C separation or a component D1 terminal) via an A/D converting unit 32A, a digitalized video signal obtained by converting an analog video input from an analog external input terminal 31B (such as a component D2 terminal) via the A/D converting unit 32B, and a digitalized video signal obtained by converting an analog video input from an analog external input terminal 31C (such as a component D3 terminal) via the A/D converting unit 32C.

As described above, analog video inputs supplied from outside to the input terminals 31A to 31C respectively are compatible not only to the composite video input or S(Y/C separation) input, but also the component input that uses the D terminal or the like. The video format of the analog video signal input from outside is not limited to NTSC solely, but it may also be PAL. The analog video signal input from outside may be one obtained by temporarily converting a digital video signal to an analog video signal (480 interlace, 480 progressive, 720 progressive, 1080 interlace, 1080 progressive, or the like).

Although it is not shown in the figure, digital signals from digital interfaces such as IEEE1394, DVI and HDMI may be supplied further to the selector 26.

The selector 26 selects at least one from a plurality of input digital video and audio signals and supplies the selected signal to the signal processing unit 34. (Note that a plurality of inputs are selected when picture-in-picture display or double image display is carried out.) In the signal processing unit 34, the input digital video signal is subjected to a predetermined signal process (including a front end processor setting process, back end processor setting process, scaler setting process, etc.), and the processed signal is supplied to a video display unit 14 (and/or an external display device) to display the image. Further, the device has such a structure that a video output (analog or digital) and an audio output (analog or digital), which have the same contents as those to be supplied to the video display unit 14 and speakers 15, can be output from the signal processing unit 34 to the outside of the device.

The video display unit 14 is made of, for example, a liquid crystal display, plasma display, or a flat-panel display that employs a field emission device or the like. The signal processing unit 34 carries out a predetermined signal process onto the input display audio signal to convert the signal into analog, which is then output to the speaker 15, where the audio signal is reproduced as sound.

It should be noted here that various operations of the television broadcast receiving device 11, which include the above-described various signal receiving operations, are controlled by the control unit 35 in a comprehensive manner. The control unit 35 can be made of a micro-processor (micro-processing unit: MPU) in which a firmware ROM, work RAM, etc. are built. As operation information from the operation unit 16 or operation information transmitted from a remote controller 17 are received via a light receiving unit 18, the control unit controls each member such as to reflect each operation content.

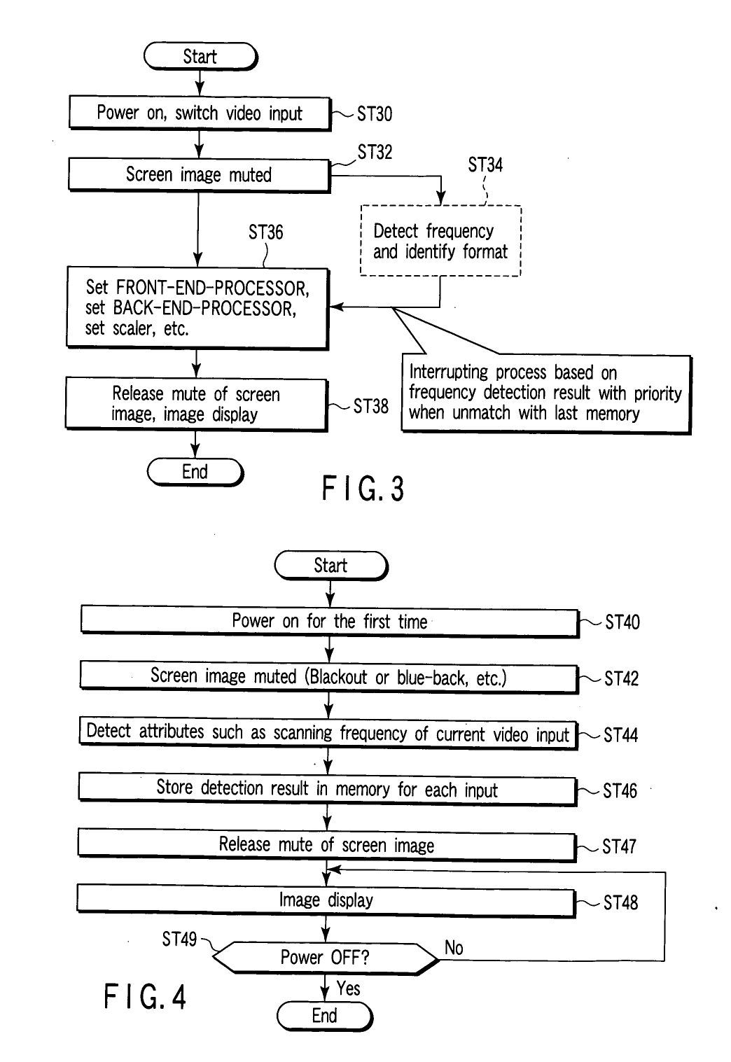

The control unit 35 is connected to a memory unit 36 which stores (in a last memory function) the latest data or the like in accordance with the formats of the input signals to the input terminals 31A to 31C (and, in some case, if needed, the signal formats from the tuner unit 29 and units 24A to 24C). The memory unit 36 may be made of a ROM that stores a control program (such as a firmware corresponding to the process shown in FIGS. 3 to 5) executed by MPU of the control unit 35, a RAM that provides a work area for the MPU, and a non-volatile memory that stores various kinds of setting data, control data, etc. The control unit 35 is connected also to a device power unit 41, and thus the MPU of the control device can grasp the ON/OFF state of the power. The ON/OFF instruction of the power unit 41 and the signal switching instruction by the selector 26 can be made using the operation unit 16 or the remote controller 17.

The control unit 35 is connected to the HDD unit (and/or DVD video recorder unit) 20 housed in a stand 13. In this case, a line 37 that supplies power electricity and control signals from the control unit 35 to the unit 20 serves to connect the control unit 35 and the unit 20 to each other via a connecting unit 38.

Further, a line 39 that transmits and receives digital video and audio signals between the control unit 35 and the HDD unit (and/or DVD video recorder unit) 20 serves to connect the control unit 35 and the unit 20 to each other via a connecting unit 40 such as IEEE1394. In other words, the device is formed to have such a structure that the transmission of digital video and audio signals between the control unit 35 and the unit 20 can be performed by means of IEEE1394 (or HDMI or DVI), by a separate route from the power and control signals.

The television broadcasting receiving device 11 can record, with the HDD unit (and/or DVD video recorder unit) 20, digital video and audio signals selected by the selector 26, and reproduce the digital video and audio signals stored in the unit 20 for viewers.

The video device setting method according to the invention can be practically carried out by a video device with such a structure as shown in FIG. 2. This method is able to deal with such a situation that the following various cases are present, that is, for example, in the case where a 480i analog video signal input of the D1 terminal 31A is switched to a 480i analog video signal input of the D2 terminal 31B (without a change in format of input video signal), in the case where a 480i analog video signal input of the D1 terminal 31A is switched to a 480p analog video signal input of the D2 terminal 31B (with a change in format of input video signal), in the case where a 480p analog video signal input of the D2 terminal 31B is switched to a 480p analog video signal input of the D3 terminal 31C (without a change in format of input video signal), and in the case where a 480p analog video signal input of the D2 terminal 31B is switched to a 1080i analog video signal input of the D3 terminal 31C (with a change in format of input video signal). In such a situation, if the format of the input video signal is not changed even when the input is switched, the image outputting time can be shortened.

Further, with the video device setting method according to the invention, in the case where the power is turned ON after it was once turned OFF while there is not change in the format of the input video signal, the image outputting time can be shortened.

FIG. 3 is a flowchart briefly illustrating an image device setting process according to an embodiment of the invention. In this process, after muting an image, the registers in the device is directly set based on the format data stored in advance by the last memory function. If the results of the frequency detection or the like, which is carried out in parallel therewith, are different from the data stored by the last memory function, the setting of the registers is once again carried out by an interrupt process. With this method, when the input signal matches with the last memory data, the image outputting time can be shortened by the time period required for the frequency detection. Or, if the signal does not match with the last memory data, an image outputting time will not exceed substantially that of the conventional technique.

With regard to a video device (digital TV) having such a structure as shown in FIG. 2, when the power is turned On or the input video is switched (step ST30), the screen of the image display unit 14 is muted (black-out, blue-back, etc.) until the predetermined image setting process is completed (step ST32). After that, the predetermined setting process is executed in accordance with the format data stored in the memory unit 36 through the last memory function (step ST36). This setting process required a certain period of time (details will be later explained). While this processing time, the scan frequency or the like of the external video input selected by the selected at that time is detected, and the format of the video input is determined based on the results of the detection, and this process is executed in parallel (step ST34).

Here, if the format determined in step ST34 and the format data (last memorized) used in the process of step ST36 match with each other, the setting process of step ST36 proceeds without depending on the results of the detection obtained in step ST34. When the setting process is finished, the image mute is released, and the image of the external video input selected by the selector 26 at that point is displayed (step ST38). During this process, the frequency of the video input is detected in step ST34; however the setting process of step ST36 already proceeds without waiting for the result of the detection process. In this manner, the time required from the screen mute in step ST32 to the image output in step ST38 can be shortened. (Note that the process of ST 34 proceeds simultaneously with the processes of ST32 to ST36.)

It should be noted that the format determined by step ST34 and the format data (last memorized) used in the process of step ST36 do not match with each other, the format data stored by the last memory function cannot be utilized. In this case, the process of step ST36 is interrupted with the format determined by step ST34 (higher priority given to the result of the frequency detection). Here, the setting process in step ST36 is carried out after the results of the process in step ST34 is obtained, and therefore a certain amount of time is required from the screen mute in step ST32 to the image output in step ST38.

However, in many actual cases, the format determined in step ST34 and the format data (last memorized) used in the process of step ST36 can match with each other. In these cases, the process quickly reaches the image output process in step ST 38 without waiting for the result of the process in step ST34. Therefore, when the entire actual use status is considered, the time required from the screen mute in step ST32 to the image output in step ST38 can be shortened in many situations.

The following are examples of the setting process carried out in step ST36.

<Front End Processor Setting>

YC separation (Separation of brightness signal/chroma signal: in the case of composite video input)

VBI data process (Data process during vertical blanking period: Simultaneous process, Auto-aspect process, etc.)

NR process (Noise reduction process for brightness and/or chroma)

<Backend Processor Setting (Image Quality Setting)>

Brightness Y system . . . . Contrast, light intensity, image quality correction

Color difference Cb/Cr system . . . color phase, color density, etc.

Gamma setting

<Scaler Setting>

Angle of view setting

FIG. 4 is a flowchart illustrating the process carried out when the power is turned on for the first time in the video device shown in FIG. 1. This process is carried out in the case where a user newly purchased a digital TV such as shown in FIG. 2 and he or she is about to view a reproduced image after setting up the device and an external video device is connected to one of the external input terminals 31A to 31C. When the setting up of the device is finished and the power of the TV is turned ON (step ST40), first, the screen is muted until the format of the video signal to be output is identified (step ST42). The screen mute state includes not only the state where the screen is in a blackout state or blue-back state, but also the state where such a guidance by characters as “PLEASE STAND BY” is output on a predetermined background image.

During the screen mute, the attributes such as scanning frequency and the like of the current video input are detected (step ST44). For example, in the case where a 480i signal of a DVD video player is input to the input terminal 31B shown in FIG. 2 and the signal is selected by the selector 25, the attributes such as the frame rate (60 Hz) and aspect ratio are detected together with the frequency (15.75 kHz).

The detection results (format data) are stored (through the last memory function) in the memory unit 36 for each input (each time one of the input terminals 31A to 31C is selected by the selector 26 in the example shown in FIG. 2) (step ST46). Here, the setting process based on the format data stored (through the last memory function) (, which corresponds to that of step ST36 shown in FIG. 3) is carried out. After that the screen mute is released (step ST47), and the image of the video input of the input terminal 31B selected by the selector 26 is output (step ST48). When the power is turned OFF after completion of the storage of the format data for each input terminal (through the last memory function) (YES in step ST48), the process shown in FIG. 4 is finished.

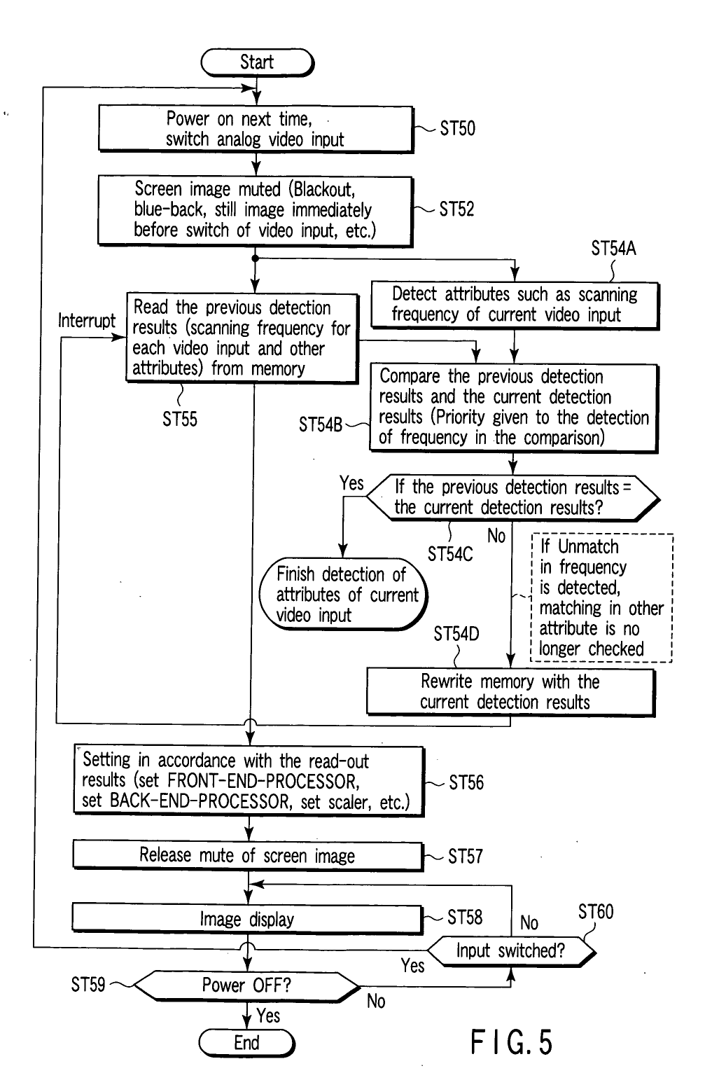

FIG. 5 is a flowchart illustrating the process carried out when the power is turned on for the next time (or the video input is switched on) in the video device shown in FIG. 1. The process shown in FIG. 5 is executed when any last memory data are stored in the memory unit 36 shown in FIG. 2 by the process shown in FIG. 4. First, when the power is turned on next time (restart of the power) after the process shown in FIG. 4, or the input is switched by the selector 26 shown in FIG. 2 while the power is ON (step ST50), the screen is muted (step ST52). The screen mute state includes not only the state where the screen is in a blackout state or blue-back state, but also the state where the last still image is displayed when some image were displayed by then. It is alternatively possible to superimpose a guidance by characters as “PLEASE STAND BY” on the still image.

Immediately after the muting of the screen image is started, the detection process for the attributes including the scanning frequency of the video input currently selected by the selector 26 is initiated (step ST54A). At the same time, the format data stored (through the last memory function) in the memory unit 36 (that is, the previous detection results) are read out, and the read out results and the detection results in step ST54A are compared with each other with a highest priority given to the result of the frequency detection (step ST54B).

If the format data (the scanning frequency, frame rate, aspect ratio, identification of interlace/progressive, identification of NTSC/PAL, etc.) in stored in the last memory function, which includes the frequency detection results match with each other (YES in step ST54C), the processes of steps ST54A to ST54C are no longer necessary to be carried out, and therefore they are finished. In this case, the format data stored through the last memory function can be applied to the video input currently selected by the selector 26, and therefore the read out results in step ST55 can be directed used for the setting of the device (in step ST56).

Here, it is important that during the processes of steps ST54A to ST54C, the device setting process of step ST56 is already started based on the read-out results in step ST55. In other words, the processes of steps ST54A to ST54C and those of steps ST55 to ST56 are carried out in parallel. Therefore, in the case where the contents of the last memory are used, the time required from when the power is turned ON (or the video input is switched) to the release of muting of the screen image (step ST57) can be shortened.

Of the format data stored by the last memory function, if there is a mismatch of frequencies compared with each other at the highest priority (NO in step ST54C), the contents stored in the memory unit 36 (the contents of the last memory) are rewritten (step ST54D) with the format data of the video input currently selected by the selector 26 or the attribute detection results (step ST54A) without performing the comparison regarding further items (frame rate and others). In this manner, the processes of steps ST55 to ST56, which are proceeding simultaneously, are interrupted. Thus, the contents which have been processed in parallel (the device setting process in step ST56 based on the previous last memory contents) are abandoned, and the device setting is carried out newly based on the rewritten contents of the last memory (step ST56). When the device setting is finished, the screen image mute is released, and the image of the video input currently selected by the selector 26 is displayed (step ST58). In this cane, the time required from when the power is turned ON (or the video input is switched) to the release of the muting of the screen image (step ST57) cannot be shortened.

While the image displaying state, if the power is turned OFF (YES in step ST59), the process shown in FIG. 5 is finished. When the power is kept ON and the input is not switched (NO in step ST59 and NO in step ST60), the display of the image of the current video input is maintained (step ST58). On the other hand, the input is switched while the power is kept ON (NO in step ST59 and YES in step ST60), the process is set back to step ST50.

Let us suppose an example here that 480i signal of a video cassette recorder is input to the input terminal 31A and a component signal (480i or 480p) of a progressive-compatible DVD video player is connected to the input terminal 31B (D2 terminal) in the structure shown in FIG. 2. Further, it is supposed in the example that the format data stored through the last memory function in the memory unit 36 is data compatible to NTSC480i signal (Aspect ratio of 4:3). In this example, when the video input is switched from the input terminal 31A to the input terminal 31B by the selector 26, and the external DVD video player outputs an NTSC480i signal (Aspect ratio of 4:3), the contents of the last memory can be utilized. In this case, the processes of steps ST54A to ST54C shown in FIG. 5 are aborted (YES in step ST54C), and the processes of steps ST55 to ST56, which are being executed in parallel at the same time, are carried out continuously as they are. Thus, the time required from when the video input is switched to when the mute of the screen image is released (step ST57) is shortened.

In the above-described example, when the video input is switched from the input terminal 31A to the input terminal 31B by the selector 26 while the external DVD video player is outputting an NTSC480p signal (Aspect ration of 4:3 or 16:9), the contents of the last memory cannot be utilized. In this case, the processes of steps ST55 to ST56 are carried out after finishing the processes of steps ST54A to ST54D shown in FIG. 5, and therefore the time required from when the video input is switched to when the mute of the screen image is released (step ST57) is prolonged. However, once the format data of the 480p signal are stored in the memory unit 36 through the last memory function, when the power is turned ON again or the video input is switched to another input terminal to which a 480p signal of the same type are input, the processes of steps ST54A to ST54D are substantially skipped, and therefore the time required until the mute of the screen image is released (step ST57) is shortened.

The programs that execute the above-described processes shown in FIGS. 3 to 5 can be stored in the firmware ROM in the MPU 100 shown in FIG. 1. Further, the work memory within the MPU 100 can be utilized as a work area used for execution of these programs.

<Advantage of the Embodiment of the Invention>

The time required to output an image can be shortened by the time taken from the detection of the frequency of the input signal to the identification of the format data.

<Summary of the Method According to the Embodiment of the Invention>

The video device setting method described with reference to FIGS. 3 to 5 takes the following steps.

That is, in the case where the latest format data is stored (by the last memory function) for each of at least one video input (ST46 or ST54D), and the video input of the stored format data is not re-selected as a current input (Input switch in step ST50 and NO in step ST54), or in the case where the power is reset when the video input of the stored format data is not a current input (Power ON next time in step ST50 and NO in step ST54C), the format data detection results of the current video input (the detection result in step ST54A) are stored (through the last memory function) as the latest format data (ST54D).

On the other hand, in the case where the video input of the stored format data is re-selected as a current input (Input switch in step ST50 and YES in step ST54), or in the case where the power is reset when the video input of the stored format data is a current input (Power ON next time in step ST50 and YES in step ST54C), the image display control is carried out based on the already stored format data (last memory data) to which the higher priority is given than the format data detection results of the current video input (the detection result in step ST54A). (That is, if YES in ST54C, the image display setting process is carried out based on the previous last memory results without rewriting the last memory.

Here, the format data contains at least the frequency data of the video inputs (such as 15.75 kHz of 480i and 31.50 kHz of 480p). Further, in the judgment as to whether or not the video input of the stored format data is re-selected as a current input (Input switch in step ST50 and YES in step ST54C) or judgment as to whether or not the power is reset when the video input of the stored format data is a current input (Power ON next time in step ST50 and YES in step ST54C), the judgment as to whether or not the frequency data of the stored format data match with the frequency data of the format data of the current video input, is given the highest priority.

Further, the processes of the image display control that use the format data stored in advance (last memory) (that is, ST55 to ST58) are carried out in parallel with the processes of judging whether or not the video input of the stored format data is re-selected as a current input (Input switch in step ST50 and YES in step ST54C) or judging whether or not the power is reset when the video input of the stored format data is a current input (Power ON next time in step ST50 and YES in step ST54C) (that is, ST54A to ST54C).

<Summary of Device or Apparatus According to the Embodiment of the Invention>

The video device shown in FIGS. 1 and 2 (that is, a digital TV according to the embodiment of the invention) that employs the video device setting method described with reference to FIGS. 3 to 5 comprises a television tuner unit (29, etc.), at least one video input unit (31A to 31C), a selector (26) that selects, as a video input, a video signal received by the television tuner unit or a video signal supplied to one of the at least one video input units, and a memory (36) that stores format data of the video input, the device further comprising:

means (35) for detecting a format of a video input selected by the selector and storing (through a last memory function) the latest format data in the memory;

means (35) for storing (through a last memory function) a result of detection of format data of a current video input as the latest format data in the memory, when the video input of the format data previously stored in the memory is not re-selected as a current input, or when the video input of the format data previously stored in the memory is not a current input and further a power is reset;

means (35) for carrying out image display control based on the format data previously stored (through a last memory function) in the memory with priority rather than the result of detection of the format data of the current video input, when the video input of the format data previously stored in the memory is re-selected as a current input, or when the video input of the format data previously stored in the memory is a current input and further a power is reset; and

an image display unit (14) that displays an image corresponding to the video input obtained as a result of the image display control (release of muting of the screen image).

It should be noted that in the case where the device according to the embodiment of the invention is realized in the form of a product other than a TV monitor (that is, for example, an image processor, video switcher or set top box), the television tuner unit and/or video display unit may be omitted in accordance with the specification of the product.

It should be noted that the invention is not limited to the above-described embodiment, but it may be modified into various versions as long as the essence of the invention does not fall out of the scope, in practical use thereof in the present or future based on the technology available at that time. For example, the embodiment shown in FIG. 1 shows, as an example, a TV set (or video monitor) equipped with a flat-surface display device; however the structure and processes described with reference to FIGS. 2 to 5 can be realized in an apparatus or device that has no display device. Further, the invention can be applied to personal computers equipped with an external video inputs. Alternatively, the invention can be applied to video projectors having similar functions that can be realized by the structure and processes described with reference to FIGS. 2 to 5.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of setting a video device, comprising:
storing latest format data for each of at least one video input unit;
storing a result of detection of format data of a current video input as the latest format data when a video input of the format data previously stored is not re-selected as a current input, or when the video input of the format data previously stored is not a current input and further a power is reset;
carrying out image display control based on the previously stored format data with priority rather than the result of detection of the format data of the current video input, when the video input of the format data previously stored is re-selected as a current input, or when the video input of the format data previously stored is a current input and further a power is reset.

2. The method according to claim 1, wherein
the format data include at least frequency data of a video input; and
a judgment as to whether the video input of the stored format data is re-selected as a current input or judgment as to whether the power is reset when the video input of the stored format data is a current input, includes a judgment as to whether the frequency data of the stored format data match with the frequency data of the format data of the current video input as a highest priority item.

3. The method according to claim 1, wherein the image display control that use the format data stored in advance is carried out in parallel with the judgment as to whether the video input of the stored format data is re-selected as a current input or the judgment as to whether the power is reset when the video input of the stored format data is a current input.

4. The method according to claim 2, wherein the image display control that use the format data stored in advance is carried out in parallel with the judgment as to whether the video input of the stored format data is re-selected as a current input or the judgment as to whether the power is reset when the video input of the stored format data is a current input.

5. A video device comprising:
at least one video input unit;
a selector that selects, as a video input, a video signal supplied to one of the at least one video input unit;
a memory that stores format data of the video input;
means for detecting a format of a video input selected by the selector and storing the latest format data in the memory;
means for storing a result of detection of format data of a current video input as the latest format data in the memory, when the video input of the format data previously stored in the memory is not re-selected as a current input, or when the video input of the format data previously stored in the memory is not a current input and further a power is reset; and
means for carrying out image display control based on the format data previously stored in the memory with priority rather than the result of detection of the format data of the current video input, when the video input of the format data previously stored in the memory is re-selected as a current input, or when the video input of the format data previously stored in the memory is a current input and further a power is reset.

6. The video device according to claim 5, wherein
the format data include at least frequency data of a video input; and
a judgment as to whether the video input of the stored format data is re-selected as a current input or judgment as to whether the power is reset when the video input of the stored format data is a current input, includes a judgment as to whether the frequency data of the stored format data match with the frequency data of the format data of the current video input as a highest priority item.

7. The video device according to claim 5, wherein the image display control that use the format data stored in advance is carried out in parallel with the judgment as to whether the video input of the stored format data is re-selected as a current input or the judgment as to whether the power is reset when the video input of the stored format data is a current input.

8. The video device according to claim 6, wherein the image display control that use the format data stored in advance is carried out in parallel with the judgment as to whether the video input of the stored format data is re-selected as a current input or the judgment as to whether the power is reset when the video input of the stored format data is a current input.

9. An video device comprising:
a television tuner unit;
at least one video input unit;
a selector that selects, as a video input, a video signal received by the television tuner unit or a video signal supplied to one of the at least one video input units;
a memory that stores format data of the video input;
means for detecting a format of the video input selected by the selector and storing the latest format data in the memory;
means for storing a result of detection of format data of a current video input as the latest format data in the memory, when the video input of the format data previously stored in the memory is not re-selected as a current input, or when the video input of the format data previously stored in the memory is not a current input and further a power is reset;
means for carrying out image display control based on the format data previously stored in the memory with priority rather than the result of detection of the format data of the current video input, when the video input of the format data previously stored in the memory is re-selected as a current input, or when the video input of the format data previously stored in the memory is a current input and further a power is reset; and
an image display unit that displays an image corresponding to the video input obtained as a result of the image display control.
